(19) United States
(12) Patent Application Publication
(10) Pub. No.: US 2026/0189879 A1
(43) Pub. Date: Jul. 2, 2026

(54) APPARATUS, SYSTEM, AND METHOD OF BLUETOOTH BROADCAST

(71) Applicant: INTEL CORPORATION, Santa Clara, CA (US)

(72) Inventors: Chandrashekar Devegowda, B.T.S Main Road (IN); Anshu Agarwal, Yemlur (IN); Mythili Hegde, Bangalore (IN); Srinivas Krovvidi, Hyderabad (IN); Vinay Prasad B R, Bangalore (IN); Tarun Arora, Bengaluru (IN)

(73) Assignee: INTEL CORPORATION, Santa Clara, CA (US)

(21) Appl. No.: 19/002,585

(22) Filed: Dec. 26, 2024

(51) Int. Cl. H04W 4/06; H04W 12/033

(52) U.S. Cl. CPC H04W 4/06; H04W 12/033

(57) ABSTRACT

For example, an apparatus may include logic and circuitry configured to cause a Bluetooth (BT) broadcast transmitter to transmit one or more broadcast data Protocol Data Units (PDUs) including broadcast data. For example, the BT broadcast transmitter may be configured to transmit a broadcast control PDU after the one or more broadcast data PDUs. For example, the broadcast control PDU may include an opcode field and a control data field. For example, the opcode field may include a predefined opcode value configured to indicate a recipient-targeted data PDU type. For example, the control data field may include targeted data for one or more targeted recipients.

### BACKGROUND

A first Bluetooth device may be configured as a broadcast transmitter, which may broadcast data, which may be received by one or more second Bluetooth devices operating as broadcast recipients, e.g., according to a Bluetooth broadcast protocol.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of transmission of broadcast Protocol Data Units (PDUs), in accordance with some demonstrative aspects.

FIG. 3 is a schematic illustration of a broadcast control PDU, in accordance with some demonstrative aspects.

FIG. 4 is a schematic flow-chart illustration of a method of initializing security keys for Bluetooth (BT) broadcast, in accordance with some demonstrative aspects.

FIG. 5 is a schematic flow-chart illustration of a method of communicating recipient-targeted data in a BT broadcast transmission, in accordance with some demonstrative aspects.

FIG. 6 is a schematic flow-chart illustration of a method of BT broadcast, in accordance with some demonstrative aspects.

FIG. 7 is a schematic flow-chart illustration of a method of BT broadcast, in accordance with some demonstrative aspects.

FIG. 8 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing Bluetooth standards (“the Bluetooth standards”), e.g., including the Bluetooth Core Specification (Bluetooth Core Specification V 5.3, Jul. 13, 2021), and/or future versions and/or derivatives thereof, devices and/or networks operating in accordance with existing IEEE 802.11 standards (including IEEE 802.11-2020 (IEEE 802.11-2020, IEEE Standard for Information Technology-Telecommunications and Information Exchange between Systems Local and Metropolitan Area Networks-Specific Requirements; Part 11: Wireless LAN Medium Access Control (MAC) and Physical Layer (PHY) Specifications, December 2020)) and/or future versions and/or derivatives thereof, devices and/or networks operating in accordance with existing cellular specifications and/or protocols, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects are described herein with respect to Bluetooth (BT) communication, e.g., according to a BT protocol and/or a BT Low Energy (BLE) protocol. However, other aspects may be implemented with respect to any other communication scheme, network, standard and/or protocol.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

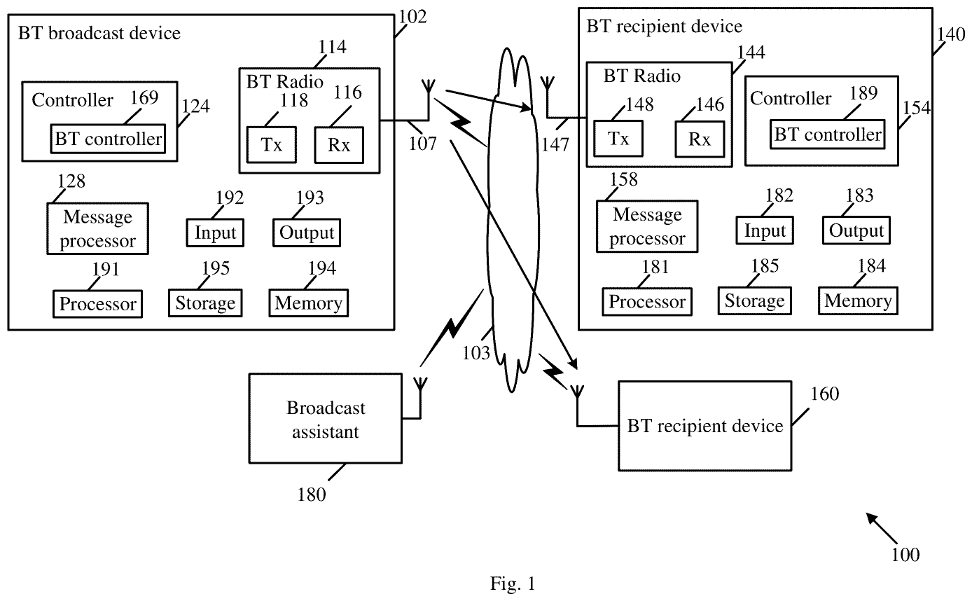

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, devices 102, 140, and/or 160 may include, operate as, and/or perform the functionality of one or more BT devices.

In some demonstrative aspects, device 102 may include a BT mobile device, device 140 may include a BT mobile device, and/or device 160 may include a BT mobile device. In other aspects, device 102, device 140, and/or device 160 may include a non-mobile BT device.

In one example, devices 102, 140, and/or 160 may include BT Low Energy (LE) (BLE) compatible devices. In other aspects, devices 102, 140, and/or 160 may include or implement any other additional or alternative BT communication functionality, e.g., according to any other additional or alternative BT protocol.

In some demonstrative aspects, devices 102, 140 and/or 160 may include, operate as, and/or perform the functionality of one or more STAs. For example, device 102 may include at least one station (STA), device 140 may include at least one STA, and/or devices 160 may include at least one STA.

In some demonstrative aspects, devices 102, 140 and/or 160 may include, operate as, and/or perform the functionality of one or more WLAN STAs.

In some demonstrative aspects, devices 102, 140 and/or 160 may include, operate as, and/or perform the functionality of one or more Wi-Fi STAs, e.g., Wi-Fi 8 STAs.

In one example, a STA may include a logical entity that is a singly addressable instance of a medium access control (MAC) and physical layer (PHY) interface to the wireless medium (WM). The STA may perform any other additional or alternative functionality.

In other aspects, devices 102, 140 and/or 160 may include, operate as, and/or perform the functionality of any other type of STA and/or device.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Bluetooth (BT) channel, a Wi-Fi channel, a cellular channel, a 5G channel, an IR channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices.

In some demonstrative aspects, devices 102, 140, and/or 160 may include one or more BT radios including circuitry and/or logic to perform wireless communication between devices 102, 140, 160, and/or one or more other BT devices.

For example, device 102 may include one or more BT radios 114, and/or device 140 may include one or more BT radios 144.

In some demonstrative aspects, BT radios 114 and/or BT radios 144 may include one or more wireless receivers (Rx) including circuitry and/or logic to receive wireless communication signals, RF signals, frames, blocks, transmission streams, packets, messages, data items, and/or data. For example, a BT radio 114 may include at least one receiver 116, and/or a BT radio 144 may include at least one receiver 146.

In some demonstrative aspects, BT radios 114 and/or 144 may include one or more wireless transmitters (Tx) including circuitry and/or logic to transmit wireless communication signals, RF signals, frames, blocks, transmission streams, packets, messages, data items, and/or data. For example, a BT radio 114 may include at least one transmitter 118, and/or a BT radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, BT radios 114 and/or 144 may include or may be implemented as part of a wireless Network Interface Card (NIC), and the like.

In some demonstrative aspects, BT radios 114 and/or 144 may be configured to communicate over a 2.4 GHz band, and/or any other band.

In some demonstrative aspects, BT radios 114 and/or 144 may include, or may be associated with one or more antennas.

In some demonstrative aspects, device 102 may include one or more antennas 107, e.g., connected to the BT radio 114, and/or device 140 may include one or more antennas 147, e.g., connected to the BT radio 144.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a BT device, e.g., a BT device implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a BT device, e.g., a BT device implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of BT radio 114, and/or at least part of the functionality of controller 154 may be implemented as part of one or more elements of BT radio 144.

In other aspects, the functionality of controller 124 may be implemented as part of any other element of device 102, and/or the functionality of controller 154 may be implemented as part of any other element of device 140.

In some demonstrative aspects, controller 124 may include, operate as, perform a role of, and/or perform one or more functionalities of, a BT controller 169, which may be configured to control BT activities of BT radio 114, e.g., as described below.

In some demonstrative aspects, controller 154 may include, operate as, perform a role of, and/or perform one or more functionalities of, a BT controller 189, which may be configured to control BT activities of BT radio 144, e.g., as described below.

In some demonstrative aspects, BT controller 169 may include, or may be implemented, partially or entirely, by circuitry and/or logic, e.g., one or more processors including circuitry and/or logic, memory circuitry and/or logic, MAC circuitry and/or logic, and/or any other circuitry and/or logic, configured to perform the functionality of BT controller 169. Additionally or alternatively, one or more functionalities of BT controller 169 may be implemented by logic, which may be executed by a machine and/or one or more processors, e.g., as described below.

In one example, BT controller 169 may include circuitry and/or logic, for example, one or more processors including circuitry and/or logic, to cause, trigger and/or control BT radio 114 to perform one or more operations, communications and/or functionalities, e.g., as described below. In one example, BT controller 169 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, BT controller 189 may include, or may be implemented, partially or entirely, by circuitry and/or logic, e.g., one or more processors including circuitry and/or logic, memory circuitry and/or logic, MAC circuitry and/or logic, and/or any other circuitry and/or logic, configured to perform the functionality of BT controller 189. Additionally or alternatively, one or more functionalities of BT controller 189 may be implemented by logic, which may be executed by a machine and/or one or more processors, e.g., as described below.

In one example, BT controller 189 may include circuitry and/or logic, for example, one or more processors including circuitry and/or logic, to cause, trigger and/or control BT radio 144 to perform one or more operations, communications and/or functionalities, e.g., as described below. In one example, BT controller 189 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of BT radio 114, and/or at least part of the functionality of message processor 158 may be implemented as part of BT radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more BT radios 114. For example, the chip or SoC may include one or more elements of controller 124, one or more elements of message processor 128, and/or one or more elements of one or more BT radios 114. In one example, controller 124, message processor 128, and one or more BT radios 114 may be implemented as part of the chip or SoC.

In other aspects, controller 124, message processor 128 and/or one or more BT radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more BT radios 144. For example, the chip or SoC may include one or more elements of controller 154, one or more elements of message processor 158, and/or one or more elements of one or more BT radios 144. In one example, controller 154, message processor 158, and one or more BT radios 144 may be implemented as part of the chip or SoC.

In other aspects, controller 154, message processor 158 and/or one or more BT radios 144 may be implemented by one or more additional or alternative elements of device 140.

In some demonstrative aspects, device 102, device 140, and/or device 160 may be configured to implement one or more settings, features, operations and/or functionalities of BT communication in accordance with one or more protocols and/or standards, for example, in accordance with one or more Bluetooth Specifications.

In some demonstrative aspects, device 102, device 140, and/or device 160 may be configured to implement one or more operations and/or functionalities of a BT broadcast mechanism, which may be configured to support broadcasting one or more broadcast data packets to one or more wireless communication devices, e.g., as described below.

In some demonstrative aspects, device 102, device 140, and/or device 160 may be configured to implement one or more operations and/or functionalities of a BT broadcast mechanism, which may be configured to provide a technical solution to support broadcasting of one or more broadcast data packets including multicast data to one or more selected users, e.g., as described below.

For example, Bluetooth broadcasting may involve sending data from a Bluetooth broadcast device to one or more, e.g., multiple, other devices using broadcast packets. For example, the BT broadcast device may use the BT broadcasting to transmit information to all nearby BT devices in range, for example, without needing to establish a direct connection with the other BT devices.

For example, some Bluetooth broadcasting mechanisms may be inefficient and/or may result in degraded performance. For example, according to some traditional Bluetooth broadcasting mechanisms, data may be transmitted to all devices within range multiple times, which may lead to increased Bandwidth utilization, inefficiencies and/or lack of personalization.

For example, the repeated transmissions to the multiple users may consume unnecessary bandwidth, which may lead to wasting bandwidth on the redundant transmissions of the same data.

For example, traditional Bluetooth broadcasting mechanisms may not be able to support personalization of broadcasted data.

For example, a broadcasting mechanism that is limited to broadcasting the same date to all devices, e.g., without distinguishing between intended recipients, may expose sensitive data, which may lead to security risks.

For example, a broadcasting mechanism that is limited to broadcasting the same data to multiple devices, e.g., to all devices, may lack support of personalization, for example, to support different user profiles.

For example, a broadcasting mechanism that is limited broadcasting the same data to multiple devices may not be able to support unicast and/or multicast transmissions. For example, unicast communication may require establishing a unicast connection between a BT transmitter and a BT receiver. For example, it may be inefficient to implement multicast communication by using multiple BT transmitters to transmit to multiple BT receivers. For example, such an implementation may result in increased channel noise and/or packet corruption.

In some demonstrative aspects, device 102, device 140, and/or device 160 may be configured to implement one or more operations and/or functionalities of a BT broadcast mechanism, which may be configured to provide a technical solution to support a single transmitter to efficiently multicast data to multiple selected users, for example, without requiring retransmissions of the same data, e.g., as described below.

In some demonstrative aspects, device 102, device 140, and/or device 160 may be configured to implement one or more operations and/or functionalities of a BT broadcast mechanism, which may be configured to provide a technical solution to support a single transmitter to efficiently multicast data to multiple selected users, for example, while securely ensuring each user receives data specific to their profile, e.g., as described below.

In some demonstrative aspects, device 102, device 140, and/or device 160 may be configured to implement one or more operations and/or functionalities of a BT broadcast mechanism, which may be configured to provide a technical solution to support targeted broadcast to one or more, e.g., multiple, users, for example, while avoiding redundant retransmissions, e.g., as described below.

In some demonstrative aspects, device 102, device 140, and/or device 160 may be configured to implement one or more operations and/or functionalities of a BT broadcast mechanism, which may be configured to provide a technical solution to support targeted broadcast to one or more, e.g., multiple, users, for example, while ensuring data security with personalized metadata, e.g., as described below.

In some demonstrative aspects, device 102, device 140, and/or device 160 may be configured to implement one or more operations and/or functionalities of a BT broadcast mechanism, which may be configured to provide a technical solution to support transmission of personalized data for a receiver, e.g., for each receiver, for example, based on metadata and/or user profiles, e.g., as described below.

For example, a broadcast transmission may be configured to provide a technical solution to support a receiver, e.g., each receiver, to process only its personalized data, for example, after filtering and decrypting the broadcast, e.g., as described below.

In some demonstrative aspects, device 102, device 140, and/or device 160 may be configured to implement one or more operations and/or functionalities of a BT broadcast mechanism, which may be configured to provide a technical solution to support a single transmitter in leveraging a BT broadcast, for example, to send data to one or more targeted receivers, e.g., as described below.

In some demonstrative aspects, device 102, device 140, and/or device 160 may be configured to implement one or more operations and/or functionalities of a BT broadcast mechanism, which may be configured to avoid repetition of data transmissions to all receivers, for example, to provide a technical solution with improved efficiency and/or performance, e.g., as described below.

In some demonstrative aspects, device 102, device 140, and/or device 160 may be configured to implement one or more operations and/or functionalities of a BT broadcast mechanism, which may be configured to leverage a BT broadcast protocol to support targeted communication, by a broadcast transmitter, e.g., a single broadcast transmitter, as described below.

In some demonstrative aspects, device 102, device 140, and/or device 160 may be configured to implement one or more operations and/or functionalities of a BT broadcast mechanism, which may be configured to leverage a BT broadcast protocol to support targeted unicast communication by a broadcast transmitter, e.g., a single broadcast transmitter, as described below.

In some demonstrative aspects, device 102, device 140, and/or device 160 may be configured to implement one or more operations and/or functionalities of a BT broadcast mechanism, which may be configured to leverage a BT broadcast protocol to support targeted multicast communication by a broadcast transmitter, e.g., a single broadcast transmitter, as described below.

In some demonstrative aspects, device 102, device 140, and/or device 160 may be configured to implement one or more operations and/or functionalities of a BT broadcast mechanism, which may be configured to support a single BT transmitter to transmit broadcast data to one or more targeted receivers, for example, even without retransmitting one or more data packets, for example, to provide a technical solution to improve, e.g., optimize, bandwidth utilization, e.g., as described below.

In some demonstrative aspects, the BT broadcast mechanism may be configured to support the single BT transmitter in sending broadcast data with control Protocol Data Units (PDUs), e.g., vendor specific control PDUs, for example, to indicate to one or more targeted receivers that data in the PDUs is not a retransmission, and that the PDUs include new data that needs to be consumed, e.g., as described below.

In some demonstrative aspects, the BT broadcast mechanism may be configured to provide a technical solution to support efficient use of control PUDs, e.g., vendor specific control PDUs, for packet identification, for example, to avoid redundancy, and/or to support efficient BW utilization, e.g., as described below.

In some demonstrative aspects, the BT broadcast mechanism may be configured to provide a technical solution to use a message, e.g., a sparse message, to support addition of personalized data, e.g., as described below.

In some demonstrative aspects, the BT broadcast mechanism may be configured to provide a technical solution, which supports enhanced security and/or a data personalization feature in targeted broadcast, e.g., as described below.

In some demonstrative aspects, device 102, device 140, and/or device 160 may be configured to implement one or more operations and/or functionalities of a BT broadcast mechanism, which may utilize a broadcast assistant, e.g., as described below.

In some demonstrative aspects, system 100 may include a broadcast assistant 180, which may be configured to coordinate, manage, and/or assist in, one or more BT broadcast transmissions, e.g., as described below.

In some demonstrative aspects, broadcast assistant 180 may be implemented as a tool or system that may help manage and/or facilitate the broadcasting operations according to the BT broadcast mechanism, e.g., as described below.

In some demonstrative aspects, broadcast assistant 180 may be configured to generate user profiles for registered users, and/or to provide unique encryption/decryption keys to a BT transmitter, e.g., as described below.

In some demonstrative aspects, the broadcast assistant 180 may be configured to provide a technical solution to support initial key exchange and/or to support user profiles for one or more recipient devices, e.g., as described below.

In some demonstrative aspects, the broadcast assistant 180 may be configured to support implementation of one or more security mechanisms, to provide security for broadcast data, for example, by leveraging one or more suitable crypto algorithms, e.g., as described below.

In some demonstrative aspects, the broadcast assistant 180 may be configured to distribute unique encryption/decryption keys to the recipient devices, e.g., as described below.

In some demonstrative aspects, device 102, device 140, and/or device 160 may be configured to implement one or more operations and/or functionalities of a BT broadcast mechanism, which may support a broadcast transmitter, e.g., device 102, to perform one or more operations, and/or functionalities of an Artificial Intelligence (AI)-powered transmitter, for example, to encrypt and/or personalize data for recipient devices, for example, based on the user profiles, e.g., as described below.

In some demonstrative aspects, the broadcast transmitter, e.g., device 102, may be configured to broadcast tailored data, for example, with vendor specific control PDUs and/or profile-specific metadata, for example, using a sparse message, e.g., as described below.

In some demonstrative aspects, device 102, device 140, and/or device 160 may be configured to implement one or more operations and/or functionalities of a BT broadcast mechanism, which may support broadcast recipients, e.g., device 140 and/or device 160, in using the unique encryption/decryption keys, for example, to filter, decrypt, and/or process relevant data.

For example, the BT broadcast mechanism may provide a technical solution to ensure efficient bandwidth usage and/or enhanced personalization while maintaining security, e.g., as described below.

In some demonstrative aspects, controller 124 may be configured to control, trigger, cause, and/or instruct a BT broadcast transmitter implemented by device 102 to transmit one or more broadcast data PDUs including broadcast data, e.g., as described below.

In some demonstrative aspects, controller 124 may be configured to control, trigger, cause, and/or instruct the BT broadcast transmitter implemented by device 102 to transmit a broadcast control PDU, for example, after the one or more broadcast data PDUs, e.g., as described below.

In some demonstrative aspects, the broadcast control PDU may be configured to include an opcode field and a control data field, e.g., as described below.

In some demonstrative aspects, the opcode field may include a predefined opcode value configured to indicate a recipient-targeted data PDU type, e.g., as described below.

In some demonstrative aspects, the control data field may include targeted data for one or more targeted recipients, e.g., as described below.

In some demonstrative aspects, the one or more broadcast data PDUs may include one or more Broadcast Isochronous (BIS) data PDUs, e.g., as described below.

In some demonstrative aspects, the broadcast control PDU may include a Broadcast Isochronous Group (BIG) control PDU, e.g., as described below.

In some demonstrative aspects, controller 124 may be configured to control, trigger, cause, and/or instruct the BT broadcast transmitter implemented by device 102 to transmit the one or more BIS data PDUs and the BIG control PDU during a same BIG event, e.g., as described below.

In other aspects, the broadcast data PDUs and/or the broadcast control PDU may include any other suitable type of broadcast PDUs.

In some demonstrative aspects, the recipient-targeted data PDU type may include a multicast data PDU type, e.g., as described below.

In some demonstrative aspects, the targeted data may include targeted data for a plurality of targeted recipients, for example, when the recipient-targeted data PDU type includes the multicast data PDU type, e.g., as described below.

In some demonstrative aspects, the recipient-targeted data PDU type may include a unicast data PDU type, e.g., as described below.

In some demonstrative aspects, the targeted data may include targeted data for a single targeted recipient, for example, when the recipient-targeted data PDU type includes the unicast data PDU type, e.g., as described below.

In other aspects, the recipient-targeted data PDU type may include any other data PDU type.

In some demonstrative aspects, the predefined opcode value in the opcode field may include a vendor specific opcode value, e.g., as described below.

In some demonstrative aspects, the predefined opcode value may be different from 0x00, e.g., as described below.

In some demonstrative aspects, the predefined opcode value may be different from 0x01, e.g., as described below.

In other aspects, the predefined opcode value may include any other vendor specific opcode value.

In some demonstrative aspects, controller 124 may be configured to control, trigger, cause, and/or instruct the BT broadcast transmitter implemented by device 102 to encrypt the targeted data, for example, according to a data encryption key for the one or more targeted recipients, e.g., as described below.

In some demonstrative aspects, controller 124 may be configured to control, trigger, cause, and/or instruct the BT broadcast transmitter implemented by device 102 to encrypt the broadcast control PDU, for example, according to a control encryption key, e.g., as described below.

In some demonstrative aspects, the data encryption key may be different from the control encryption key, e.g., as described below.

In some demonstrative aspects, controller 124 may be configured to control, trigger, cause, and/or instruct the BT broadcast transmitter implemented by device 102 to coordinate the data encryption key with a broadcast assistant, for example, broadcast assistant 180, e.g., as described below.

In some demonstrative aspects, controller 124 may be configured to control, trigger, cause, and/or instruct the BT broadcast transmitter implemented by device 102 to transmit a first broadcast control, e.g., as described below.

In some demonstrative aspects, the first broadcast control PDU may be configured to include targeted data for one or more first targeted recipients, e.g., as described below.

In some demonstrative aspects, controller 124 may be configured to control, trigger, cause, and/or instruct the BT broadcast transmitter implemented by device 102 to transmit a second broadcast control PDU, e.g., as described below.

In some demonstrative aspects, the second broadcast control PDU may be configured to include targeted data for one or more second targeted recipients, e.g., as described below.

For example, the first broadcast control PDU may include targeted data for device 140 and/or one or more other first targeted recipients, and the second broadcast control PDU may include targeted data for device 160 and/or one or more other second targeted recipients.

In some demonstrative aspects, controller 124 may be configured to control, trigger, cause, and/or instruct the BT broadcast transmitter implemented by device 102 to configure the targeted data to be included in the broadcast control PDU, for example, based on a recipient profile to define one or more attributes of data to be provided to the one or more targeted recipients, e.g., as described below.

In some demonstrative aspects, controller 154 may be configured to control, trigger, cause, and/or instruct a BT broadcast recipient implemented by device 140 to process one or more broadcast data PDUs from a BT broadcast transmitter, for example, to identify broadcast data from the BT broadcast transmitter, e.g., as described below.

For example, the one or more broadcast data PDUs may include the one or more broadcast data PDUs sent from the BT broadcast transmitter implemented by device 102, e.g., as described above.

In some demonstrative aspects, controller 154 may be configured to control, trigger, cause, and/or instruct the BT broadcast recipient implemented by device 140 to process an opcode field in a broadcast control PDU from the BT broadcast transmitter, e.g., the BT broadcast transmitter implemented by device 102, e.g., as described below.

In some demonstrative aspects, the broadcast control PDU may be after the one or more broadcast data PDUs, e.g., as described below.

In some demonstrative aspects, controller 154 may be configured to control, trigger, cause, and/or instruct the BT broadcast recipient implemented by device 140 to process a control data field in the broadcast control PDU, for example, based on a determination that the opcode field includes a predefined opcode value configured to indicate a recipient-targeted data PDU type, e.g., as described below.

In some demonstrative aspects, controller 154 may be configured to control, trigger, cause, and/or instruct the BT broadcast recipient implemented by device 140 to process the control data field, for example, to identify targeted data for one or more targeted recipients, e.g., as described below.

In some demonstrative aspects, the one or more broadcast data PDUs may include one or more BIS data PDUs, e.g., as described below.

In some demonstrative aspects, the broadcast control PDU may include a BIG control PDU, e.g., as described below.

In some demonstrative aspects, controller 154 may be configured to control, trigger, cause, and/or instruct the BT broadcast recipient implemented by device 140 to receive the one or more BIS data PDUs and the BIG control PDU during a same BIG event, e.g., as described below.

In some demonstrative aspects, controller 154 may be configured to control, trigger, cause, and/or instruct the BT broadcast recipient implemented by device 140 to decrypt the targeted data, for example, according to a data encryption key for the one or more targeted recipients, e.g., as described below.

In some demonstrative aspects, controller 154 may be configured to control, trigger, cause, and/or instruct the BT broadcast recipient implemented by device 140 to decrypt the broadcast control PDU, for example, according to a control encryption key, e.g., as described below.

In some demonstrative aspects, the data encryption key may be different from the control encryption key, e.g., as described below.

In some demonstrative aspects, controller 154 may be configured to control, trigger, cause, and/or instruct the BT broadcast recipient implemented by device 140 to identify the data encryption key, for example, based on information from a broadcast assistant, e.g., broadcast assistant 180, e.g., as described below.

In some demonstrative aspects, device 102, device 140, and/or device 160 may be configured to implement one or more operations and/or functionalities of a BT broadcast mechanism, which may be configured to support enhanced bandwidth efficiency and/or security, e.g., as described below.

In some demonstrative aspects, device 102, device 140, and/or device 160 may be configured to implement one or more operations and/or functionalities of a BT broadcast mechanism, which may be configured to support a single BT transmitter to send personalized and/or encrypted data to one or more specific, e.g., targeted, receivers, e.g., as described below.

In some demonstrative aspects, device 102, device 140, and/or device 160 may be configured to implement one or more operations and/or functionalities of a BT broadcast mechanism, which may be configured to leverage vendor-specific control PDUs, for example, to communicate the personalized and/or encrypted data to the one or more targeted receivers, e.g., as described below.

In some demonstrative aspects, device 102, device 140, and/or device 160 may be configured to implement one or more operations and/or functionalities of a BT broadcast mechanism, which may be configured to provide a technical solution to optimize bandwidth utilization, for example, by avoiding retransmissions, e.g., as described below.

In some demonstrative aspects, device 102, device 140, and/or device 160 may be configured to implement one or more operations and/or functionalities of a BT broadcast mechanism, which may be configured to provide a technical solution to support an AI-powered system, for example, to manage data personalization and/or security, e.g., as described below.

In some demonstrative aspects, device 102, device 140, and/or device 160 may be configured to implement one or more operations and/or functionalities of a BT broadcast mechanism, which may be configured to utilize broadcast control PDUs, which may be used to manage various link-layer operations, e.g., in accordance with the Bluetooth Specification.

In some demonstrative aspects, device 102, device 140, and/or device 160 may be configured to implement one or more operations and/or functionalities of a BT broadcast mechanism, which may be configured to support communication of vendor-specific control PDUs, which may be configured to transmit data to the targeted recipients, and to indicate that the transmitted data is new and not a retransmission, e.g., as described below.

For example, a broadcast transmitter, e.g., device 102, may be able to notify a broadcast receiver, e.g., device 140, that the transmitted data is new and not a retransmission, for example, to provide a technical solution to reduce, e.g., minimize retransmissions, in a way which may ensure efficient bandwidth usage.

For example, receivers may filter out unnecessary data, for example, based on profile-specific metadata embedded in the vendor-specific control PDUs.

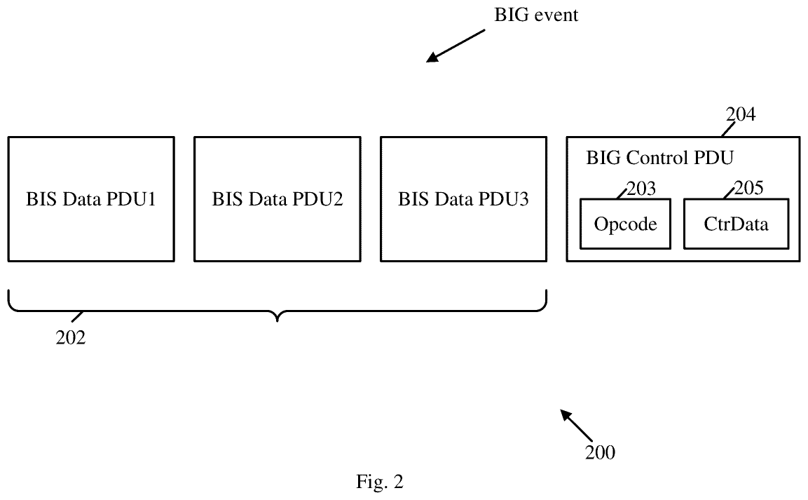

Reference is made to FIG. 2, which schematically illustrates a transmission of broadcast PDUs 200, in accordance with some demonstrative aspects.

For example, device 102 (FIG. 1), device 140 (FIG. 1), and/or device 160 (FIG. 1) may be configured to communicate one or more of the broadcast PDUs 200.

For example, device 102 (FIG. 1) may operate as a BT broadcast transmitter to generate, configure, and transmit the broadcast PDUs 200, e.g., as described above.

For example, device 140 (FIG. 1) and/or device 160 (FIG. 1) may operate as a BT broadcast recipient to receive and process one or more, e.g., some or all, of the broadcast PDUs 200.

In some demonstrative aspects, as shown in FIG. 2, broadcast PDUs 200 may include one or more broadcast data PDUs 202 including broadcast data.

In some demonstrative aspects, as shown in FIG. 2, broadcast PDUs 200 may include a broadcast control PDU 204 after the one or more broadcast data PDUs 202. For example, device 102 (FIG. 1) may transmit the broadcast control PDU 204 after the broadcast data PDUs 202, e.g., as described above.

In some demonstrative aspects, as shown in FIG. 2, the one or more broadcast data PDUs 202 may include one or more BIS data PDUs, which may be configured, for example, in accordance with the BT Specification.

In some demonstrative aspects, as shown in FIG. 2, broadcast control PDU 204 may include a BIG control PDU.

In some demonstrative aspects, as shown in FIG. 2, a BT broadcast transmitter, e.g., device 102 (FIG. 1), may transmit the one or more BIS data PDUs 202 and the BIG control PDU 204 during a same BIG event.

In some demonstrative aspects, as shown in FIG. 2, broadcast control PDU 204 may include an opcode field 203, e.g., as described below.

In some demonstrative aspects, opcode field 203 may include a predefined opcode value configured to indicate a recipient-targeted data PDU type, e.g., as described below.

In other aspects, opcode field 203 may include any other additional or alternative information.

In some demonstrative aspects, as shown in FIG. 2, broadcast control PDU 204 may include a control data field 205, for example, after the opcode field 203, e.g., as described below.

In some demonstrative aspects, control data field 205 may include targeted data for one or more targeted recipients, e.g., as described below.

In other aspects, control data field 205 may include any other additional or alternative information.

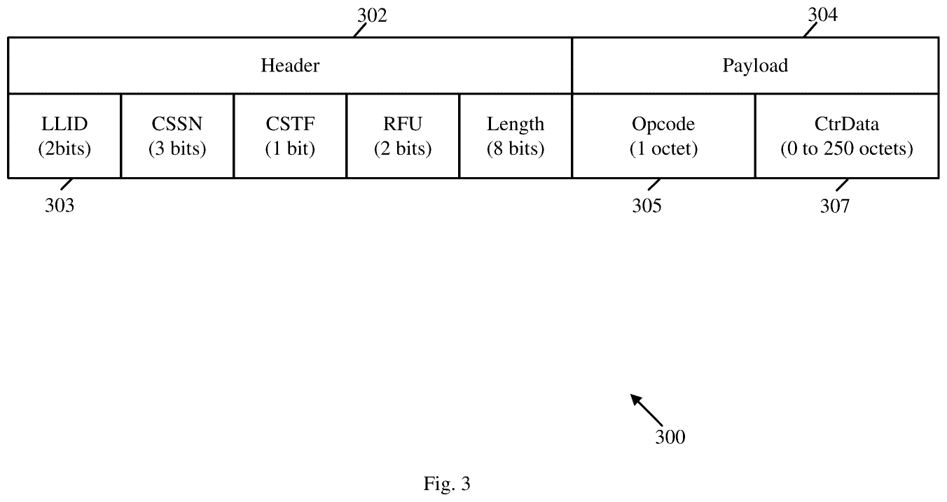

Reference is made to FIG. 3, which schematically illustrates a broadcast control PDU 300, in accordance with some demonstrative aspects.

For example, device 102 (FIG. 1) may be configured to generate broadcast control PDU 300, and device 140 (FIG. 1) may be configured to process the broadcast control PDU 300 received from device 102 (FIG. 1).

In some demonstrative aspects, broadcast control PDU 300 may be configured as a BIG control PDU, e.g., in accordance with the Bluetooth Specification.

In some demonstrative aspects, as shown in FIG. 3, broadcast control PDU 300 may include a header field 302.

In some demonstrative aspects, header field 302 may include a 16-bit header. In other aspects, header field 302 may include a header of any other length.

In some demonstrative aspects, as shown in FIG. 3, header field 302 may include a Logical Link Identifier (LLID) field 303, which may be configured to indicate a type of content of a payload field of broadcast control PDU 300.

For example, LLID field 303 may include the value ‘0b11’ to indicate a broadcast control PDU. In another example, LLID field 303 may include any other predefined value to indicate a broadcast control PDU.

In some demonstrative aspects, as shown in FIG. 3, broadcast control PDU 300 may include a payload field 304, for example, after the header field 302.

In some demonstrative aspects, as shown in FIG. 3, payload field 304 may include an opcode field 305 configured to identify a type of the broadcast control PDU 300.

In some demonstrative aspects, opcode field 305 may include a predefined opcode value configured to indicate a recipient-targeted data PDU type.

In some demonstrative aspects, the predefined opcode value may include a vendor specific opcode value.

In some demonstrative aspects, the value of opcode field 305 may be configured, for example, in accordance with the Bluetooth Specification, e.g., as follows:

TABLE 1

| Opcode | BIG Control PDU Name |
|---|---|
| 0x00 | BIG_CHANNEL_MAP_IND |
| 0x01 | BIG_TERMINATE_IND |
| 0xF8 to 0xFB | Reserved for future use (used |
| | for specification development |
| | purposes) |
| All other values | Reserved for future use |

In some demonstrative aspects, the predefined opcode value to indicate the recipient-targeted data PDU type may be different from the values 0x00 and 0x01.

For example, as shown in Table 1, the ‘0x00’ value may be used for a BIG_CHANNEL_MAP_IND control PDU, and the value ‘0x01’ value may be used for a BIG_TERMINATE_IND control PDU.

In some demonstrative aspects, the predefined opcode value to indicate the recipient-targeted data PDU type may include a predefined value, for example, from the range of values between 0xF8 and 0xFB. For example, as shown in Table 1, these values may be reserved for future use.

In some demonstrative aspects, the predefined opcode value to indicate the recipient-targeted data PDU type may include a predefined value, for example, from the range of values between 0xFC and 0xFF. For example, as shown in Table 1, these values may be reserved for future use.

For example, opcode field 305 may be set to a value indicating a vendor specific control PDU, e.g., a value in the range between 0xFC and 0xFF. For example, a plurality of different vendor-specific values may be defined for opcode field 305, for example, to indicate a plurality of different unicast packet types.

For example, a Bluetooth device, which does not support the recipient-targeted data PDU type, may ignore the broadcast control PDU, for example, based on the vendor-specific value in opcode field 305.

For example, the vendor specific values of the opcode field 305 may be utilized to provide a technical solution to support the recipient-targeted data PDU type, for example, while allowing Interoperability (IOP), and/or without requiring an update to the Bluetooth Specification.

In some demonstrative aspects, as shown in FIG. 3, the payload field 304 of broadcast control PDU 300 may include a control data field (CtrData) 307, for example, after the opcode field 305, e.g., as described below.

In some demonstrative aspects, the control data field 307 may include targeted data for one or more targeted recipients, e.g., as described below.

In some demonstrative aspects, the targeted data in control data field 307 may be encrypted, for example, to a data encryption key for the one or more targeted recipients, e.g., as described below.

In some demonstrative aspects, the broadcast control PDU 300 may be encrypted, for example, according to a control encryption key, for example, in accordance with the Bluetooth Specification.

In some demonstrative aspects, the data encryption key may be, for example, different from the control encryption key.

In some demonstrative aspects, the broadcast control PDU 300 may be configured to communicate multicast data. For example, the opcode field 305 may be set to a predefined value to indicate a multicast data PDU type, and the control data field 307 may be set to include targeted data for a plurality of targeted recipients.

In some demonstrative aspects, the broadcast control PDU 300 may be configured to communicate unicast data. For example, the opcode field 305 may be set to a predefined value to indicate a unicast data PDU type, and the control data field 307 may be set to include targeted data for a single targeted recipient.

Referring back to FIG. 1, in some demonstrative aspects, device 102 may be configured to perform one or more operations and/or functionalities of a broadcast transmitter, for example, an AI-based transmitter, which may be configured to dynamically personalize data, for example, based on user profiles for one or more broadcast recipients, e.g., as described below.

For example, the AI-based transmitter may utilize an AI engine to process user registration data, and to dynamically adjust a broadcast content, for example, to suit each receiver's preferences and/or needs. For example, the AI engine may be configured to ensure that each receiver gets personalized data in a single broadcast.

In some demonstrative aspects, device 102, device 140, and/or device 160 may be configured to implement one or more operations and/or functionalities of a BT broadcast mechanism, which may be configured to support communication of personalized and/or encrypted data transmissions, e.g., as described below.

In some demonstrative aspects, the broadcast transmitter, for example, the AI-based transmitter, e.g., implemented by device 102, may use public keys provided, for example, by broadcast assistant 180, for example, to encrypt data intended for one or more specific receivers (also referred to as “targeted recipients”), e.g., as described below.

For example, the public encryption keys may be used to encrypt the data for the one or more specific receivers, for example, to ensure that only an intended, e.g., targeted, recipient may decrypt and consume the data.

In some demonstrative aspects, the broadcast transmitter, for example, the AI-based transmitter, e.g., implemented by device 102, may be configured to tailor a broadcast content to one or more, e.g., each, user's profile, for example, by embedding personalized data in a broadcast transmission, e.g., as described below.

For example, a recipient, e.g., each receiver, may receive its own unique data, for example, even though a message is broadcasted once.

In some demonstrative aspects, device 102, device 140, and/or device 160 may be configured to implement one or more operations and/or functionalities of a BT broadcast mechanism, which may be configured to support communication of sparse messages with metadata, e.g., as described below.

In some demonstrative aspects, device 102, device 140, and/or device 160 may be configured to implement one or more operations and/or functionalities of a BT broadcast mechanism, which may be configured to provide a technical solution to reduce, e.g., minimize, an amount of unnecessary data transmitted, for example, by sending sparse messages including lightweight, targeted messages containing only relevant information for each receiver, e.g., as described below.

In some demonstrative aspects, device 102 may be configured to implement one or more operations and/or functionalities of a BT broadcast mechanism, which may be configured to support transmitting one or more broadcast messages including metadata, which may be configured to help the recipient devices to identify and filter the broadcast messages intended for them, e.g., as described below.

For example, the metadata may include control information, which may be embedded in a vendor-specific control PDU. For example, the control information may include one or more receiver Identifiers (IDs) to identify one or more recipients, and/or any other additional or alternative information.

In some demonstrative aspects, broadcast assistant 180 may be configured to implement one or more operations and/or functionalities of a user registration mechanism, which may be configured to support registration of one or more BT broadcast recipients and/or key distribution to the one or more BT broadcast recipients, e.g., as described below.

In some demonstrative aspects, broadcast assistant 180 may be configured to implement one or more operations and/or functionalities of a user registration mechanism, which may be configured to manage encryption setups, for example, to provide a technical solution to support encryption and/or secure communication of messages between a BT broadcast transmitter, e.g., device 102, and one or more BT broadcast recipients, e.g., device 140 and/or 160, e.g., as described below.

In some demonstrative aspects, broadcast assistant 180 may be configured to implement one or more operations and/or functionalities of a user registration mechanism, which may be configured to manage key distribution, e.g., directly or via integration with one or more other systems, for example, to provide a technical solution to support encryption and/or secure communication of messages between a BT broadcast transmitter, e.g., device 102, and one or more BT broadcast recipients, e.g., device 140 and/or 160, e.g., as described below.

In some demonstrative aspects, broadcast assistant 180 may be configured to implement one or more operations and/or functionalities of a user registration mechanism, which may be configured to facilitate receiver registration and authentication, and/or to monitor security aspects, for example, to provide a technical solution to support encryption and/or secure communication of messages between a BT broadcast transmitter, e.g., device 102, and one or more BT broadcast recipients, e.g., device 140 and/or 160, e.g., as described below.

In some demonstrative aspects, one or more BT broadcast recipients, e.g., device 140, may first register with broadcast assistant 180, e.g., which may be acting as a central component responsible for managing user profiles, generating encryption/decryption keys, and ensuring secure communication, e.g., as described below.

For example, broadcast assistant 180 may be configured to be responsible for user registration. For example, broadcast assistant 180 may create user profiles for a device, e.g., each device, for example, during registration.

For example, broadcast assistant 180 may be configured to be responsible for key generation. For example, broadcast assistant 180 may generate unique public-private key pairs for each receiver. For example, broadcast assistant 180 may share with a BT broadcast transmitter, e.g., implemented by device 102, a public key of a public-private key pair assigned to a BT broadcast receiver. For example, broadcast assistant 180 may securely send to the BT broadcast receiver a private key of the public-private key pair assigned to the BT broadcast receiver.

For example, broadcast assistant 180 may be responsible for profile management. For example, broadcast assistant 180 may manage user profiles, which may be used to store preferences, security keys, and/or any other additional or alternative data, e.g., which may be required for personalization.

In some demonstrative aspects, device 140 may be configured to implement one or more operations and/or functionalities of a BT broadcast mechanism, which may be configured to support decryption and processing of targeted data received from a BT broadcast transmitter, e.g., device 102, e.g., as described below.

In some demonstrative aspects, device 140 may be configured to implement one or more operations and/or functionalities of a BT broadcast mechanism, which may be configured to support decryption and processing of the targeted data, for example, according to a data encryption key received from broadcast assistant 180, e.g., as described below.

In some demonstrative aspects, device 140 may be configured to scan a broadcast for vendor-specific control PDUs, e.g., as described below.

In some demonstrative aspects, device 140 may be configured to use metadata in a received broadcast message, for example, to identify which broadcast messages are intended for the device 140, and to filter out broadcast messages not intended for device 140, e.g., as described below.

In some demonstrative aspects, device 140 may be configured to use one or more private keys, which may be securely distributed by broadcast assistant 180, for example, to decrypt personalized messages sent by the BT broadcast transmitter, e.g., as described below.

In some demonstrative aspects, device 140 may be configured to process personalized data, for example, after decrypting the personalized message, e.g., as described below.

In some demonstrative aspects, the BT broadcast mechanism may provide a technical solution to achieve efficient and/or personalized communication without requiring multiple transmissions, for example, by supporting the communication of the personalized data, which may be tailored to a BT broadcast recipient, e.g., device 140.

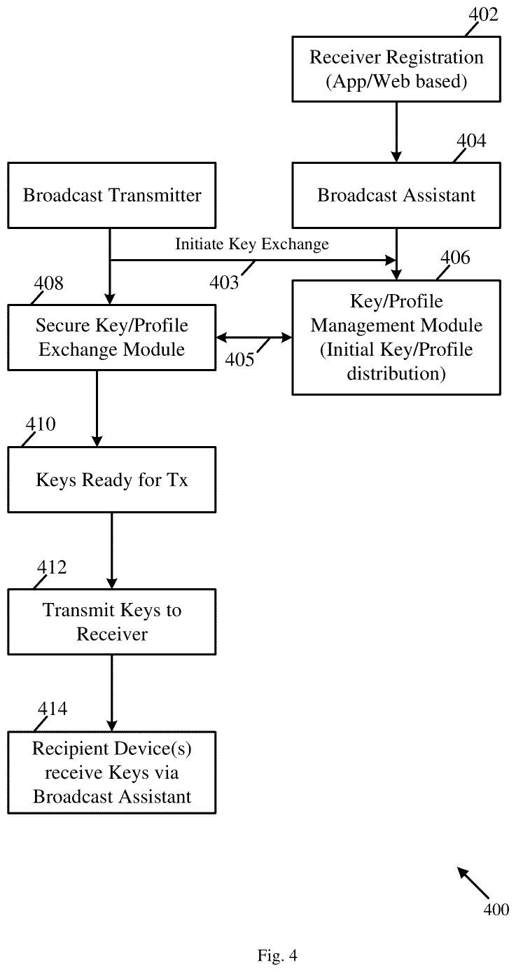

Reference is made to FIG. 4, which schematically illustrates a method 400 of initializing security keys for BT broadcast, in accordance with some demonstrative aspects.

For example, device 102 (FIG. 1), device 140 (FIG. 1), device 160 (FIG. 1), and/or broadcast assistant 180 (FIG. 1) may be configured to implement one or more operations and/or functionalities of the method of FIG. 4, for example, to perform initial key exchange and/or connection setup for BT broadcast, e.g., as described below.

In some demonstrative aspects, the method 400 may be configured to leverage a broadcast assistant functionality, for example, to provide a technical solution to support creating and/or managing user profiles, e.g., as described below.

In some demonstrative aspects, the method 400 may include setting up a secure communication channel between a BT broadcast transmitter, e.g., device 102 (FIG. 1), and one or more BT broadcast recipients, e.g., device 140 (FIG. 1) and/or device 160 (FIG. 1), for example, by exchanging encryption keys.

In some demonstrative aspects, encryption and/or decryption of broadcast data may be handled securely, for example, using asymmetric cryptography.

In some demonstrative aspects, a broadcast assistant, e.g., broadcast assistant 180 (FIG. 1), may be configured to generate unique keys for a receiver, e.g., for each receiver, for example, during the initialization phase, e.g., as described below.

In some demonstrative aspects, as indicated at block 402, the method may include registering one or more BT broadcast recipients, e.g., end devices, for example, via an application (app), a web-based interface, and/or the like.

For example, a registration process may involve providing device information and/or creating a user profile.

For example, during the registration process with the broadcast assistant, a BT broadcast recipient, e.g., each BT broadcast recipient, may generate a public-private key pair, for example, using a standard asymmetric cryptographic algorithm, for example, a Rivest-Shamir-Adleman (RSA) algorithm, an Elliptic Curve Cryptography (ECC) algorithm, and/or any other suitable cryptographic algorithm.

For example, an asymmetric encryption, e.g., according to an RSA algorithm or an ECC algorithm, may ensure that even though the data is broadcasted to all BT broadcast recipients, only intended, e.g., targeted, BT broadcast recipients may decrypt segments meant for them, thereby maintaining data confidentiality.

In some demonstrative aspects, as indicated at block 404, the method may include managing the registration process at the broadcast assistant. For example, the broadcast assistant may be configured to maintain user profiles, to generate encryption keys, and/or to assist with secure connection setup.

In some demonstrative aspects, as indicated by arrow 403, the method may include initiating at the BT broadcast transmitter key exchange with the broadcast assistant, e.g., as described below.

In some demonstrative aspects, the broadcast assistant may include a key/profile management module responsible for generating and/or distributing initial encryption keys.

In some demonstrative aspects, as indicated by arrow 405, the method may include coordinating a data encryption key between the BT broadcast transmitter and the broadcast assistant.

In some demonstrative aspects, as indicated at block 406, the method may include generating, e.g., at the key/profile management module, a unique public-private key pair for each BT broadcast recipient, for example, once the BT broadcast recipients are registered with the broadcast assistant.

In some demonstrative aspects, as indicated by arrow 405, the method may include sending one or more public keys from the broadcast assistant to the BT broadcast transmitter.

For example, the public keys from the one or more BT broadcast recipients may be shared with the BT broadcast transmitter, for example, via the broadcast assistant, e.g., during the initialization phase.

For example, the public keys, being non-sensitive, may be shared openly with the BT broadcast transmitter for encryption.

In some demonstrative aspects, as indicated by arrow 405, the method may include securely distributing one or more private keys from the broadcast assistant to the one or more BT recipients.

For example, the private keys may remain securely stored on each BT broadcast recipient, for example, ensuring that only the BT broadcast recipient may decrypt data intended for it.

In some demonstrative aspects, the broadcast assistant may periodically refresh encryption keys, for example, to maintain an increased level of security. For example, the broadcast assistant may generate new key pairs for BT broadcast recipients, and may securely distribute new public keys to the BT broadcast transmitter.

For example, the broadcast assistant and the BT broadcast transmitter may perform an exchange of public keys, for example, over a secure channel, e.g., using a Transport Layer Security (TLS) protocol or the like, for example, to ensure that the public keys cannot be tampered with during transit.

In some demonstrative aspects, as indicated at block 408, the method may include receiving the public keys from the broadcast assistant, e.g., at a secure key/profile exchange module of the BT broadcast transmitter.

For example, the secure key/profile exchange module may ensure secure storage of the public keys. For example, the secure key/profile exchange module may be configured to prepare the public keys for transmission.

In some demonstrative aspects, as indicated at block 410, the method may include preparing the public keys for use in an actual data transmission, for example, after a successful key exchange.

In some demonstrative aspects, as indicated at blocks 412 and 414, the method may include completing the key exchange phase, for example, by securely transmitting the private keys from the broadcast assistant to the respective BT broadcast recipients.

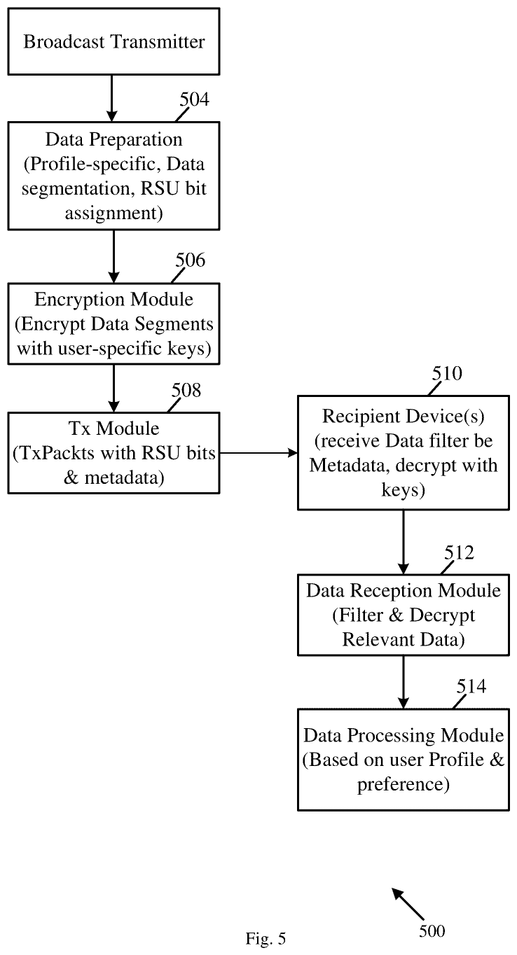

Reference is made to FIG. 5, which schematically illustrates a method 500 of communicating recipient-targeted data in a BT broadcast transmission, in accordance with some demonstrative aspects.

For example, device 102 (FIG. 1), device 140 (FIG. 1), and/or device 160 (FIG. 1) may be configured to implement one or more operations and/or functionalities of the method of FIG. 5.

For example, device 102 (FIG. 1), device 140 (FIG. 1), and/or device 160 (FIG. 1) may be configured to implement one or more operations of the method of FIG. 5, for example, to support data transfer of recipient-targeted data via broadcast transmissions according to a BT broadcast mechanism, e.g., as described below.

In some demonstrative aspects, one or more operations of the method 500 may be implemented to securely and efficiently transmit personalized, encrypted data from a BT broadcast transmitter, e.g., device 102 (FIG. 1), to one or more, e.g., multiple, BT broadcast recipients, for example, device 140 (FIG. 1) and/or device 160 (FIG. 1), e.g., as described below.

In some demonstrative aspects, the method 500 may utilize vendor-specific control PDUs, for example, to provide a technical solution to optimize bandwidth usage, for example, by reducing, e.g., minimizing, unnecessary retransmissions, e.g., as described below.

For example, the vendor-specific control PDUs may be utilized to provide a technical solution to ensure reduced, e.g., minimal, retransmissions, which may support reduction in the processing and/or bandwidth overhead.

In some demonstrative aspects, as indicated in block 504, the method may include preparing at the BT broadcast transmitter personalized data segments for one or more BT broadcast recipients, e.g., for each BT broadcast recipient, for example, based on their unique profiles.

In some demonstrative aspects, data preparation of the personalized data segments may include preparing profile-specific metadata, which may include, for example, information specific to a BT broadcast recipient's profile. For example, the profile-specific metadata may be configured to help a receiver to filter broadcasted content, and/or to identify which portions are intended for the receiver.

For example, the profile-specific metadata may be utilized to provide technical solution to guarantee that only the relevant data is processed by a BT broadcast recipient. For example, this guarantee may support reduced processing and/or bandwidth overhead.

In some demonstrative aspects, the data preparation may include preparing at the BT broadcast transmitter vendor-specific control PDUs, which may be embedded in broadcast transmissions.

For example, the vendor-specific control PDUs may be configured to indicate that transmitted data is new, e.g., not a retransmission.

For example, the vendor-specific control PDUs may be configured to work in tandem with the profile-specific metadata, for example, to ensure efficient bandwidth usage, for example, by preventing recipients from processing redundant data, for example, such that the recipients may focus only on new transmissions.

In some demonstrative aspects, as indicated in block 506, the method may include encrypting data segments, e.g., at an encryption module of the BT broadcast transmitter. For example, the encryption module may encrypt the data segments, for example, using receiver-specific public keys, for example, to ensure that only designated receivers may decrypt and access the data. For example, the BT broadcast transmitter may receive the receiver-specific public keys from a broadcast assistant, e.g., as described above with reference to FIG. 4.

In some demonstrative aspects, as indicated in block 508, the method may include transmitting the encrypted data segments, for example, along with the vendor-specific control PDUs and/or the profile-specific metadata, e.g., from a Tx module of the BT broadcast transmitter.

For example, the vendor-specific control PDUs may indicate that the data is new (“fresh”), e.g., not a retransmission. For example, the profile-specific metadata may ensure that targeted, e.g., intended, BT broadcast recipients may identify and filter the data relevant to them.

In some demonstrative aspects, as indicated in block 510, the method may include processing at a BT broadcast recipient device broadcast data from the BT broadcast transmitter.

In some demonstrative aspects, as indicated in block 510, the BT broadcast recipient device may scan the broadcast, and may analyze the profile-specific metadata and/or the vendor-specific control PDUs received from the BT broadcast transmitter.

For example, the vendor-specific control PDUs may be configured to confirm that the data is new, for example, to help avoid unnecessary retransmissions. For example, the profile-specific metadata may be configured to ensure that the BT broadcast recipient processes only data tailored to its needs.

In some demonstrative aspects, as indicated in block 512, the method may include filtering, e.g., at data reception module of the BT broadcast recipient, the received broadcast transmission, for example, using the profile-specific metadata to identify the relevant portions of data.

For example, the vendor-specific control PDUs may be conjured to prevent the BT broadcast recipient from processing retransmissions, for example, ensuring only new data is handled.

For example, the relevant data may be decrypted, for example, by using a private key of the BT broadcast recipient.

In some demonstrative aspects, as indicated at block 512, the method may include allowing the BT broadcast recipient access to personalized information, for example, once the relevant data is identified and decrypted.

In some demonstrative aspects, as indicated at block 514, the method may include processing the decrypted data, e.g., at a data processing module of the BT broadcast recipient, for example, based on a user profile and/or preferences of the BT broadcast recipient, for example, to ensure that the content is appropriately interpreted and utilized.

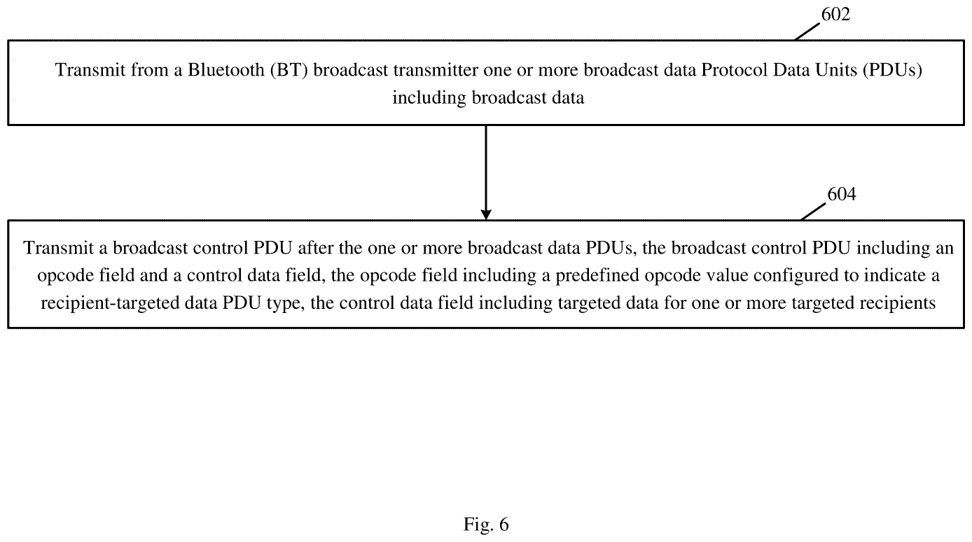

Reference is made to FIG. 6, which schematically illustrates a method of Bluetooth broadcast, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include transmitting from a BT broadcast transmitter one or more broadcast data PDUs. For example, the one or more broadcast data PDUs may include broadcast data. For example, controller 124 (FIG. 1) may be configured to cause, trigger, and/or control a BT broadcast transmitter implemented by device 102 (FIG. 1) to transmit one or more broadcast data PDUs including broadcast data, e.g., as described above.

As indicated at block 604, the method may include transmitting a broadcast control PDU after the one or more broadcast data PDUs. For example, the broadcast control PDU may include an opcode field and a control data field. For example, the opcode field may include a predefined opcode value configured to indicate a recipient-targeted data PDU type. For example, the control data field may include targeted data for one or more targeted recipients. For example, controller 124 (FIG. 1) may be configured to cause, trigger, and/or control the BT broadcast transmitter implemented by device 102 (FIG. 1) to transmit the broadcast control PDU after the one or more broadcast data PDUs, e.g., as described above.

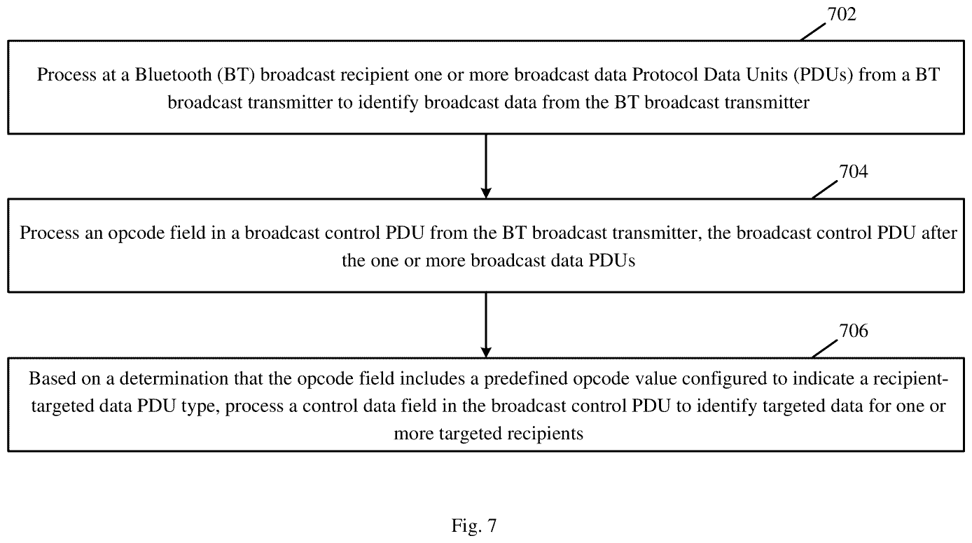

Reference is made to FIG. 7, which schematically illustrates a method of Bluetooth broadcast, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include processing, at a BT broadcast recipient, one or more broadcast data PDUs from a BT broadcast transmitter, for example, to identify broadcast data from the BT broadcast transmitter. For example, controller 154 (FIG. 1) may be configured to cause, trigger, and/or control a BT broadcast recipient implemented by device 140 (FIG. 1) to process one or more broadcast data PDUs from a BT broadcast transmitter implemented by device 102 (FIG. 1) to identify broadcast data from the BT broadcast transmitter, e.g., as described above.

As indicated at block 704, the method may include processing an opcode field in a broadcast control PDU from the BT broadcast transmitter. For example, the broadcast control PDU may be after the one or more broadcast data PDUs. For example, controller 154 (FIG. 1) may be configured to cause, trigger, and/or control the BT broadcast recipient implemented by device 140 (FIG. 1) to process the opcode field in the broadcast control PDU from the BT broadcast transmitter implemented by device 102 (FIG. 1), e.g., as described above.

As indicated at block 706, the method may include processing a control data field in the broadcast control PDU to identify targeted data for one or more targeted recipients, for example, based on a determination that the opcode field includes a predefined opcode value configured to indicate a recipient-targeted data PDU type. For example, controller 154 (FIG. 1) may be configured to cause, trigger, and/or control the BT broadcast transmitter implemented by device 140 (FIG. 1) to process a control data field in the broadcast control PDU to identify targeted data for one or more targeted recipients, for example, based on a determination that the opcode field includes a predefined opcode value configured to indicate a recipient-targeted data PDU type, e.g., as described above.

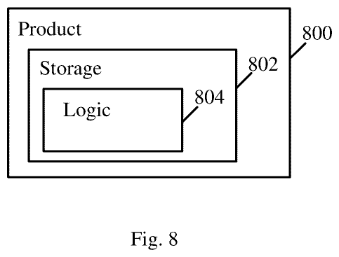

Reference is made to FIG. 8, which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations at device 102 (FIG. 1), device 140 (FIG. 1), device 160 (FIG. 1), broadcast assistant 180 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), broadcast assistant 180 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, 5, 6, and/or 7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine readable storage media 802 may include one or more types of computer-readable storage media capable of storing data, including volatile memory, non-volatile memory, removable or non-removable memory, erasable or non-erasable memory, writeable or re-writeable memory, and the like. For example, machine readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause a Bluetooth (BT) broadcast transmitter to transmit one or more broadcast data Protocol Data Units (PDUs) comprising broadcast data; and transmit a broadcast control PDU after the one or more broadcast data PDUs, the broadcast control PDU comprising an opcode field and a control data field, the opcode field comprising a predefined opcode value configured to indicate a recipient-targeted data PDU type, the control data field comprising targeted data for one or more targeted recipients.

Example 2 includes the subject matter of Example 1, and optionally, wherein the apparatus is configured to cause the BT broadcast transmitter to encrypt the targeted data according to a data encryption key for the one or more targeted recipients.

Example 3 includes the subject matter of Example 2, and optionally, wherein the apparatus is configured to cause the BT broadcast transmitter to encrypt the broadcast control PDU according to a control encryption key, wherein the data encryption key is different from the control encryption key.

Example 4 includes the subject matter of Example 2 or 3, and optionally, wherein the apparatus is configured to cause the BT broadcast transmitter to coordinate the data encryption key with a broadcast assistant.

Example 5 includes the subject matter of any one of Examples 1-4, and optionally, wherein the apparatus is configured to cause the BT broadcast transmitter to transmit a first broadcast control PDU comprising targeted data for one or more first targeted recipients, and a second broadcast control PDU comprising targeted data for one or more second targeted recipients.

Example 6 includes the subject matter of any one of Examples 1-5, and optionally, wherein the apparatus is configured to cause the BT broadcast transmitter to configure the targeted data to be included in the broadcast control PDU based on a recipient profile to define one or more attributes of data to be provided to the one or more targeted recipients.

Example 7 includes the subject matter of any one of Examples 1-6, and optionally, wherein the predefined opcode value comprises a vendor specific opcode value.

Example 8 includes the subject matter of any one of Examples 1-7, and optionally, wherein the predefined opcode value is different from 0x00 and 0x01.

Example 9 includes the subject matter of any one of Examples 1-8, and optionally, wherein the recipient-targeted data PDU type comprises a multicast data PDU type, wherein the targeted data comprises targeted data for a plurality of targeted recipients.

Example 10 includes the subject matter of any one of Examples 1-8, and optionally, wherein the recipient-targeted data PDU type comprises a unicast data PDU type, wherein the targeted data comprises targeted data for a single targeted recipient.

Example 11 includes the subject matter of any one of Examples 1-10, and optionally, wherein the one or more broadcast data PDUs comprises one or more Broadcast Isochronous (BIS) data PDUs, the broadcast control PDU comprises a Broadcast Isochronous Group (BIG) control PDU.

Example 12 includes the subject matter of Example 11, and optionally, wherein the apparatus is configured to cause the BT broadcast transmitter to transmit the one or more BIS data PDUs and the BIG control PDU during a same BIG event.

Example 13 includes the subject matter of any one of Examples 1-12, and optionally, comprising a BT radio to transmit the one or more broadcast data PDUs and the broadcast control PDU.

Example 14 includes the subject matter of Example 13, and optionally, comprising one or more antennas connected to the BT radio, and a processor to execute instructions of an operating system.

Example 15 includes an apparatus comprising logic and circuitry configured to cause a Bluetooth (BT) broadcast recipient to process one or more broadcast data Protocol Data Units (PDUs) from a BT broadcast transmitter to identify broadcast data from the BT broadcast transmitter; process an opcode field in a broadcast control PDU from the BT broadcast transmitter, the broadcast control PDU after the one or more broadcast data PDUs; and based on a determination that the opcode field comprises a predefined opcode value configured to indicate a recipient-targeted data PDU type, process a control data field in the broadcast control PDU to identify targeted data for one or more targeted recipients.

Example 16 includes the subject matter of Example 15, and optionally, wherein the apparatus is configured to cause the BT broadcast recipient to decrypt the targeted data according to a data encryption key for the one or more targeted recipients.

Example 17 includes the subject matter of Example 16, and optionally, wherein the apparatus is configured to cause the BT broadcast recipient to decrypt the broadcast control PDU according to a control encryption key, wherein the data encryption key is different from the control encryption key.

Example 18 includes the subject matter of Example 16 or 17, and optionally, wherein the apparatus is configured to cause the BT broadcast recipient to identify the data encryption key based on information from a broadcast assistant.

Example 19 includes the subject matter of any one of Examples 15-18, and optionally, wherein the predefined opcode value comprises a vendor specific opcode value.

Example 20 includes the subject matter of any one of Examples 15-19, and optionally, wherein the predefined opcode value is different from 0x00 and 0x01.

Example 21 includes the subject matter of any one of Examples 15-20, and optionally, wherein the recipient-targeted data PDU type comprises a multicast data PDU type, wherein the targeted data comprises targeted data for a plurality of targeted recipients.

Example 22 includes the subject matter of any one of Examples 15-20, and optionally, wherein the recipient-targeted data PDU type comprises a unicast data PDU type, wherein the targeted data comprises targeted data for the BT broadcast recipient.

Example 23 includes the subject matter of any one of Examples 15-22, and optionally, wherein the one or more broadcast data PDUs comprises one or more Broadcast Isochronous (BIS) data PDUs, the broadcast control PDU comprises a Broadcast Isochronous Group (BIG) control PDU.

Example 24 includes the subject matter of Example 23, and optionally, wherein the one or more BIS data PDUs and the BIG control PDU are received at the BT broadcast recipient during a same BIG event.

Example 25 includes the subject matter of any one of Examples 15-24, and optionally, comprising a BT radio to receive the one or more broadcast data PDUs and the broadcast control PDU.

Example 26 includes the subject matter of Example 25, and optionally, comprising one or more antennas connected to the BT radio, and a processor to execute instructions of an operating system.

Example 27 includes a Bluetooth (BT) device comprising the apparatus of any of Examples 1-26.

Example 28 includes a wireless communication device comprising the apparatus of any of Examples 1-26.

Example 29 includes a mobile device comprising the apparatus of any of Examples 1-26.

Example 30 includes a system comprising the apparatus of any of Examples 1-26.

Example 31 includes an apparatus comprising means for executing any of the described operations of any of Examples 1-26.

Example 32 includes a product comprising one or more tangible computer-readable non-transitory storage media comprising instructions operable to, when executed by at least one processor, enable the at least one processor to cause any of the described operations of any of Examples 1-26.

Example 33 includes an apparatus comprising: a memory interface; and processing circuitry configured to: perform any of the described operations of any of Examples 1-26.

Example 34 includes a method comprising any of the described operations of any of Examples 1-26.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a Bluetooth (BT) broadcast transmitter to:
transmit one or more broadcast data protocol data units (PDUs) comprising broadcast data; and
transmit a broadcast control PDU after the one or more broadcast data PDUs, the broadcast control PDU comprising an opcode field and a control data field, the opcode field comprising a predefined opcode value configured to indicate a recipient-targeted data PDU type, the control data field comprising targeted data for one or more targeted recipients; and
a memory to store information processed by the processor.

2. The apparatus of claim 1 configured to cause the BT broadcast transmitter to encrypt the targeted data according to a data encryption key for the one or more targeted recipients.

3. The apparatus of claim 2 configured to cause the BT broadcast transmitter to encrypt the broadcast control PDU according to a control encryption key, wherein the data encryption key is different from the control encryption key.

4. The apparatus of claim 2 configured to cause the BT broadcast transmitter to coordinate the data encryption key with a broadcast assistant.

5. The apparatus of claim 1 configured to cause the BT broadcast transmitter to transmit a first broadcast control PDU comprising targeted data for one or more first targeted recipients, and a second broadcast control PDU comprising targeted data for one or more second targeted recipients.

6. The apparatus of claim 1 configured to cause the BT broadcast transmitter to configure the targeted data to be included in the broadcast control PDU based on a recipient profile to define one or more attributes of data to be provided to the one or more targeted recipients.

7. The apparatus of claim 1, wherein the predefined opcode value comprises a vendor specific opcode value.

8. The apparatus of claim 1, wherein the predefined opcode value is different from 0x00 and 0x01.

9. The apparatus of claim 1, wherein the recipient-targeted data PDU type comprises a multicast data PDU type, wherein the targeted data comprises targeted data for a plurality of targeted recipients.

10. The apparatus of claim 1, wherein the recipient-targeted data PDU type comprises a unicast data PDU type, wherein the targeted data comprises targeted data for a single targeted recipient.

11. The apparatus of claim 1, wherein the one or more broadcast data PDUs comprises one or more broadcast isochronous (BIS) data PDUs, the broadcast control PDU comprises a broadcast isochronous group (BIG) control PDU.

12. The apparatus of claim 11 configured to cause the BT broadcast transmitter to transmit the one or more BIS data PDUs and the BIG control PDU during a same BIG event.

13. The apparatus of claim 1 comprising a BT radio to transmit the one or more broadcast data PDUs and the broadcast control PDU.

14. The apparatus of claim 13 comprising one or more antennas connected to the BT radio, and a processor to execute instructions of an operating system.

15. One or more tangible computer-readable non-transitory storage media comprising instructions operable to, when executed by at least one processor, enable the at least one processor to cause a Bluetooth (BT) broadcast transmitter to:
transmit one or more broadcast data protocol data units (PDUs) comprising broadcast data; and
transmit a broadcast control PDU after the one or more broadcast data PDUs, the broadcast control PDU comprising an opcode field and a control data field, the opcode field comprising a predefined opcode value configured to indicate a recipient-targeted data PDU type, the control data field comprising targeted data for one or more targeted recipients.

16. The one or more tangible computer-readable non-transitory storage media of claim 15, wherein the instructions, when executed, cause the BT broadcast transmitter to encrypt the targeted data according to a data encryption key for the one or more targeted recipients.

17. An apparatus comprising:
a processor configured to cause a Bluetooth (BT) broadcast recipient to:
process one or more broadcast data protocol data units (PDUs) from a BT broadcast transmitter to identify broadcast data from the BT broadcast transmitter;
process an opcode field in a broadcast control PDU from the BT broadcast transmitter, the broadcast control PDU after the one or more broadcast data PDUs; and
based on a determination that the opcode field comprises a predefined opcode value configured to indicate a recipient-targeted data PDU type, process a control data field in the broadcast control PDU to identify targeted data for one or more targeted recipients; and
a memory to store information processed by the processor.

18. The apparatus of claim 17 configured to cause the BT broadcast recipient to decrypt the targeted data according to a data encryption key for the one or more targeted recipients.

19. The apparatus of claim 18 configured to cause the BT broadcast recipient to decrypt the broadcast control PDU according to a control encryption key, wherein the data encryption key is different from the control encryption key.

20. The apparatus of claim 18 configured to cause the BT broadcast recipient to identify the data encryption key based on information from a broadcast assistant.
